(19) United States
(12) Patent Application Publication
(10) Pub. No.: US 2024/0025698 A1
(43) Pub. Date: Jan. 25, 2024

(54) ELEVATOR SYSTEM HAVING ELEVATOR OPERATING DEVICES FOR PASSENGERS WITH LIMITED MOBILITY

(71) Applicant: Inventio AG, Hergiswil (CH)

(72) Inventor: Dennys Taiana, Losone (CH)

(21) Appl. No.: 18/042,301

(22) PCT Filed: Aug. 25, 2021
(86) PCT No.: PCT/EP2021/073486

§ 371 Date: Feb. 21, 2023

(30) Foreign Application Priority Data
Aug. 31, 2020 (EP) 20193679.6

(51) Int. Cl. B66B 1/46; B66B 3/00; B66B 1/34

(52) U.S. Cl. CPC B66B 1/468; B66B 3/002; B66B 1/463; B66B 1/3461; B66B 2201/103; B66B 2201/4615; B66B 2201/4646; B66B 2201/463; B66B 2201/4661

(57) ABSTRACT

An elevator system has an elevator operating device and an activation device. The operating device is connected to the elevator controller and is arranged on a floor. The operating device has a first radio device, an audio device and a touchscreen for inputting a destination floor desired by a passenger and for outputting travel information. The activation device has an actuation device accessible to the passenger, has a second radio device for radio communication with the first radio device, and is arranged within radio range of the operating device. When the actuation device is actuated by the passenger, the second radio device transmits an activation radio signal. The operating device then switches from a normal operating mode to a special operating mode, in which an operating instruction for a call input by the passenger is generated, and when the call input is complete, switches back to the normal operating mode.

### FIELD

The technology described herein relates in general to an elevator system in a building. Design implementations of the technology relate in particular to an elevator system with elevator operating devices for passengers with limited mobility and to a method for operating such an elevator system.

### BACKGROUND

In buildings with elevator systems, elevator operating devices, by means of which a passenger can call an elevator, are arranged on the individual floors. In known elevator systems, an elevator operating device arranged on a floor has up/down buttons, such that the passenger can input the desired direction of travel. In this elevator installation, there is a car operating device in the elevator car, by means of which the passenger in the elevator car can input the desired destination floor. In other known elevator systems, the passenger can already input the destination floor at an elevator operating device on the floor. For this purpose, the elevator system is equipped with destination call control technology, and the elevator operating devices arranged on the floors each have either a keypad, a touch-sensitive screen, and/or a data acquisition device (e.g., in the form of an RFID card reader known from EP 0699617 B1) for inputting the destination floor.

Elevator operating devices should be conveniently and reliably operable even for passengers with restricted mobility. Physical disabilities may affect vision, hearing or physical mobility, for example. Different approaches are known for meeting these requirements. Elevator operating devices, for example, which each have or display a special button (for example with a symbol for a wheelchair) are generally known. If this button is actuated, the elevator system switches to a disability-friendly operating mode. In addition, it is known from EP 2 331 443 B1, for example, that an elevator operating device with a touch-sensitive screen changes to a special input mode when a type of wandering movement is detected on the touchscreen.

Although the approaches mentioned facilitate the operation of an elevator system by a passenger with a physical disability, touch-sensitive screens with a smooth surface may nevertheless represent a difficulty in operation, in particular for passengers with limited vision. There is therefore a need for a technology which facilitates operation.

### SUMMARY

One aspect of the technology described here relates to an elevator system in which an elevator car controlled by an elevator controller can be moved between floors. The elevator system comprises an elevator operating device and an activation device. The elevator operating device is communicatively connected to the elevator controller and arranged on a floor. The elevator operating device has a first radio device, an audio device and a touch-sensitive screen for inputting a destination floor desired by a passenger and for outputting travel information. The activation device has an actuation device accessible to the passenger and a second radio device for radio communication with the first radio device. The activation device is arranged on one of the floors within radio range of the elevator operating device arranged there, wherein the second radio device is configured to transmit an activation radio signal when the actuation device is actuated by the passenger. The elevator operating device is configured to switch from a normal operating mode to a special operating mode when the activation radio signal is received by the first radio device, and in the special operating mode to generate an operating instruction for a call input by the passenger and to switch to the normal operating mode when the call has been input.

Another aspect of the technology relates to a method for operating an elevator system in which an elevator operating device communicatively connected to an elevator controller is arranged on a floor and an activation device is arranged on one of the floors within radio range of the elevator operating device arranged there, wherein the elevator operating device has a normal operating mode and a special operating mode. The method comprises reception by the elevator operating device of an activation signal initiated by a passenger at the activation device. After reception of the activation signal, the special operating mode of the elevator operating device is activated, wherein the elevator operating device switches from the normal operating mode to the special operating mode. The elevator operating device then executes a routine for an operating instruction, whereby in the event of a call input at the elevator operating device the elevator operating device assists the passenger who initiated the activation signal. Once the passenger has finished the call input, the destination call is transmitted by the elevator operating device to the elevator controller. The elevator operating device communicates travel information to the passenger, wherein the travel information indicates an elevator car determined by the elevator controller and handling the destination call. Once communication of the travel information has finished, the special operating mode of the elevator operating device is deactivated, wherein the elevator operating device switches from the special operating mode to the normal operating mode.

The technology described here creates an elevator system wherein the activation device according to the technology described here can advantageously be used in combination with known elevator operating devices wherein destination floors are to be input on touch-sensitive screens (touchscreens). The use of the touch-sensitive screens can be associated with difficulties, in particular for passengers with limited vision. For passengers, in particular those with a weakness of sight, the technology described here has the advantage that it enables a desired destination floor to be comfortably input at an elevator operating device with a touchscreen. The activation device allows such passengers to activate the special operating mode of the elevator operating device, as is used, for example, in elevator systems with destination call control technology. In this special operating mode, the passenger is assisted during call input. Passengers with no physical disability, however, may still use the elevator operating device wherein they are already familiar.

In relation to the elevator operating device, the activation device can be regarded as an expansion component. Since communication between the activation device and the elevator operating device takes place by radio, little installation effort is needed. In addition, in one exemplary embodiment, a known and generally available radio technology, in particular a Bluetooth technology, is used.

In comparison with the elevator operating device, the activation device has a reduced functionality; it is only necessary for the activation signal to be generated and emitted. Depending on the design of the activation device, an acoustic signal generator and/or an illumination device can be provided. According to the technology described here, an activation device therefore has a low technical complexity and is thus also inexpensive.

In one exemplary embodiment, the elevator operating device and the at least one activation device each have a housing, wherein the housing of the at least one activation device is arranged adjacent to the housing of the elevator operating device present next to the activation device. The housing of the activation device can be arranged on the housing of the elevator operating device. In one exemplary embodiment, the activation device can be arranged on a front side of the elevator operating device on the passenger side; it can for example be glued to the front side of the elevator operating device. The at least one activation device can thereby be arranged flexibly and independently of the elevator operating device; the housings may touch one another or be arranged at a greater or lesser distance from one another.

Flexibility with respect to the arrangement is also given in that in one exemplary embodiment the activation device is equipped with a battery or another form of storage for electrical energy. In one exemplary embodiment, the activation device is equipped with a pushbutton in conjunction with an electrodynamic energy converter. When the pushbutton is pressed, the electrodynamic energy converter supplies the energy for transmitting a Bluetooth signal. For this reason, the activation device does not need to be provided with separate lines for the power supply.

### DESCRIPTION OF THE DRAWINGS

Various aspects of the improved technology are described in greater detail below with reference to exemplary embodiments in conjunction with the drawings. In the drawings, identical elements have identical reference signs. In the drawings:

FIG. 1 is a schematic view of an example of a situation in a building with a plurality of floors and of an example of an elevator system;

FIG. 2 is a schematic view of exemplary elevator operating devices and of an exemplary activation device, which in the elevator system according to FIG. 1 are arranged on a floor; and

FIG. 3 is an example of a representation of an exemplary embodiment of a method for operating the elevator system.

### DETAILED DESCRIPTION

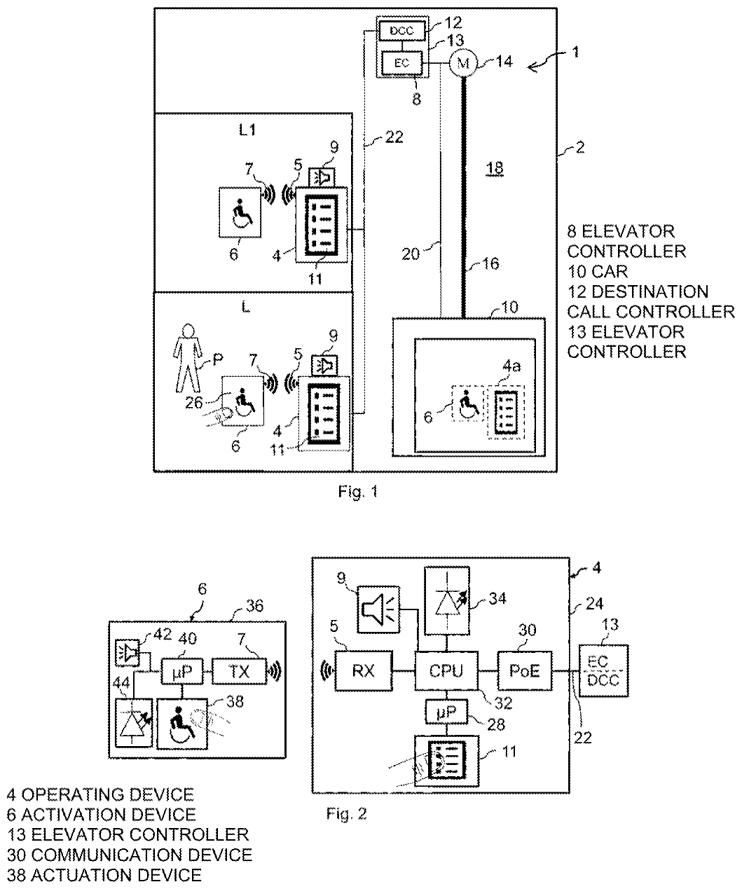

FIG. 1 is a schematic representation of an example of a situation in a building 2 that has a plurality of floors L, L1 that are served by an elevator system 1. The floor L can be an entrance hall of the building 2, which the passengers P enter when accessing the building 2 and from which the passengers leave the building 2 again. When a passenger P enters the floor L, each floor L, L1 of the building 2 can, with the appropriate access authorization, be reached from that floor by means of the elevator system 1. For the purpose of illustration, of the elevator system 1, only one elevator controller 13, a drive machine 14, a suspension means 16 (e.g., steel cables or flat belts), an elevator car 10 (hereinafter also referred to as car 10), which is suspended on the suspension means 16 and is movable in a shaft 18, and a number of elevator operating devices 4, 4a and activation devices 6 are shown in FIG. 1. A person skilled in the art will recognize that the elevator system 1 can also comprise a plurality of cars 10 in one or more shafts 18 that are controlled by a group controller. Instead of a traction elevator (shown in FIG. 1), the elevator system 1 can also have one or more hydraulic elevators.

The elevator system 1 can be configured according to one of the control technologies mentioned above (up/down controller or destination call controller). A person skilled in the art will recognize that, depending on the control technology implemented in the building 2, the elevator operating devices 4, 4a will be configured and arranged accordingly. The control technologies mentioned are known to a person skilled in the art, so that detailed explanations do not appear necessary; hereinafter, this is only discussed to the extent that it appears helpful for understanding the technology described herein.

If the elevator system 1 is equipped with a destination call controller, the elevator operating devices 4 will be arranged on floors L, L1 and be connected to a destination call controller 12 (DCC) via a communication network 22. A passenger P can input a desired destination floor at an elevator operating device 4 on the floor L, L1; after the passenger P has input the destination floor (i.e., the input of a destination call), information about the boarding floor and the destination floor will be available. The boarding floor is defined by the location of the elevator operating device 4 at which the destination floor is input. The destination call controller 12 allocates an elevator car 10 to the input destination call, and an elevator controller 8 (EC) controls the travel of the allocated elevator car 10 according to the destination call. Inside the car 10, it is usually not possible to input a travel request to a destination floor; an elevator operating device 4a in the car 10 and shown in FIG. 1 with dashed lines and the activation device 6 are not provided in an elevator system 1 with a destination call controller.

If the elevator system 1 is equipped with an on/off controller, elevator operating devices 4 will be arranged on the floors L, L1, at which a passenger P can input the desired direction of travel; the (floor-side) elevator operating devices 4 shown in FIG. 1 may be configured with a touch-sensitive screen that displays the two directions of travel, or as two directional buttons. The destination call controller 12 also shown in FIG. 1 is not provided in an elevator system 1 with an up/down controller. The elevator operating devices 4 on the floors L, L1 are connected to the elevator controller 13 via a communication network 22. Inputting the desired destination floor then takes place in the car 10 at the elevator operating device 4a arranged there. A communication line 20 connects the (car-side) elevator operating device 4a to the elevator controller 13. The current position of the car 10 (and thus the boarding floor) can be stored in the elevator controller 13; this derives from the last movement undertaken by the car 10.

In the following, a description of exemplary embodiments of the technology described here is primarily based on an elevator system 1, which is equipped with a destination call controller. The passenger P can input a desired destination floor L, L1 at the elevator operating devices 4 on the floors L, L1. For this purpose, the elevator operating devices 4 are each equipped with a touch-sensitive screen 11, for example; the touch-sensitive screen 11 is also referred to below as a touchscreen 11. Embodiments of such a touchscreen 11 and technologies that are used there for application, in particular display and input options on a flat user interface of the touchscreen 11, are known to the person skilled in the art. For example, the elevator operating devices 4 can display destination floors (e.g., in the form of individual numbered fields) and possibly associated floor-specific information (e.g., restaurant, parking garage, entry hall) on the user interface of the touchscreen 11. The car 10, to which an elevator call (destination call) is allocated in order to handle the elevator call, can be communicated to the passenger P by means of a display on the user interface and by means of a voice message via an audio device 9.

According to the technology described here, the elevator operating device 4 comprises a radio device 5, which is arranged together with the touchscreen 11 in a housing 24 (FIG. 2) of the elevator operating device 4, and the activation device 6 comprises a radio device 7, which is arranged in a housing of the activation device 6. The radio device 7 is configured to transmit an activation radio signal when the activation device 6 is actuated by the passenger P. The radio device 7 transmits the activation radio signal at a radio power and with a directional characteristic that are selected such that the activation radio signal can be reliably received within a defined radio range and direction. The radio device 5 of the elevator operating device 4 is arranged within radio range and configured to receive the activation radio signal. In one exemplary embodiment, the transmission and reception of the activation radio signal take place in accordance with a Bluetooth technology, e.g. Bluetooth Low-Energy (BLE). The person skilled in the art recognizes that another radio technology can also be implemented, for example Wi-Fi HaLow/IEEE802.11ah and Zigbee.

In the situation shown in FIG. 1, the technology described herein can be used in an advantageous manner. Summarized briefly and by way of example, the technology described here enables a passenger P with a physical limitation, in particular in the case of limited vision or blindness, to be able to input an elevator call comfortably and reliably, in an elevator system 1 in which touchscreens 11 are provided for call inputs. However, passengers P without physical disabilities may continue to use the elevator operating devices 4 they know from known elevator systems 1 with destination call control technology. Passengers P, who are, for example, blind, may be guided to one of the activation devices 6. For this purpose, for example, an acoustic signal generator, which generates, for example, a clocked harmonic sound signal with a low clock frequency (e.g., approximately 1-4 Hz or a lower frequency), and/or a blind guidance system, which comprises, for example, a tactile ground guidance system consisting of optically and tactilely contrasting ground indicators (grooved and knobbed panels), may be provided.

When the passenger P actuates the activation device 6, it sends the activation radio signal, whereupon the elevator operating device 4 switches from a normal operating mode to a special operating mode. In the normal operating mode, the elevator operating device 4 generates, for example, a graphical user interface that the passenger P can operate in a known manner by touching and reading information. In the special operating mode, the elevator operating device 4 generates an operating instruction for a call input by the passenger P. The activation device 6 is arranged at or in the elevator operating device 4. When the passenger P actuates the activation device 6, the passenger P will thus also be located at or close to the elevator operating device 4. The operating instruction generated by the elevator operating device 4 can thus be perceived by the passenger P; in particular, it can be heard. If the passenger P follows the operating instructions and interacts accordingly with the elevator operating device 4, the passenger P will thus be assisted during the call input. When the call input is complete with a transmission of travel information to the passenger P (e. g., which car 10 is allocated, its arrival time at the boarding floor and/or where it can be boarded starting from the location of the elevator operating device 4), the elevator operating device 4 will switch back to the normal operating mode.

Both in FIG. 1 and also in a specific embodiment, the activation device 6 on the passenger side can be configured with an identification device 26. The identification device 26 can have, for example, on a user interface a symbol for a wheelchair or another marking in order to identify its intended use for passengers P with a physical disability. Depending on the embodiment, the identification device 26 can comprise an illumination device 44 shown in FIG. 2, for example, in order to illuminate the user interface. In addition, an acoustic signal generator 42, also shown in FIG. 2, can be understood as included in the identification device 26.

FIG. 2 shows schematic representations of exemplary embodiments of the elevator operating device 4 and the activation device 6, as they may be used on a floor L, L1 in the elevator system 1 according to FIG. 1. The elevator operating device 6 is communicatively connected to the elevator controller 13 (EC/DCC) via the communication network 22. The elevator operating device 4 has a housing 24, whereby the elevator operating device 4 can be arranged on a building wall, an elevator door frame or standing on the floor. The activation device 6 has a housing 36, which can be arranged on a building wall, on the elevator door frame or at or on the elevator operating device 4. In the elevator car 10, the elevator operating device 4a is arranged on a car interior wall or at or on the elevator operating device 4a. A person skilled in the art would recognize that the housings 24, 36 may possibly be omitted when the elevator operating device 4 and the activation device 6 are installed in a building wall or a door frame of a floor-side elevator door. A person skilled in the art would also recognize that the elevator operating device 4 and the activation device 6 are arranged at a height that is user-friendly or prescribed by a standard.

In the exemplary embodiment shown, the touchscreen 11, a central control and processing device 32 (CPU), an illumination device 34, the audio device 9 (e.g., comprising an electro-acoustic transducer) and a communication device 30 (PoE, power over ethernet) are arranged in the housing 24 of the elevator operating device 4. In addition, the radio device 5 for receiving (RX) the activation radio signal is arranged in the housing 24. The central control and processing device 32 is communicatively connected to the components mentioned in order to ensure the operation and the tasks of the elevator operating device 4.

The touchscreen 11 comprises a processor 28 that controls the operation of the touchscreen 11 and generates, inter alia, the user interface. Since a transparent glass panel (not shown) covers the touchscreen 11, the input fields shown on the user interface are visible for passengers. The processor 28 is connected to the central control and processing device 32 and generates a signal, for example, when a passenger P touches an input field with a finger. The input fields are allocated to destination floors, wherein it is possible for floor-specific information to be displayed as well. The structure and function of a touchscreen are known to a person skilled in the art, and further explanations therefore do not appear to be necessary.

The illumination device 34 serves to illuminate the user interface of the elevator operating device 4 as a whole or only some regions thereof. Controlled by the central control and processing device 32, the illumination device 34 can illuminate the user interface such that the displayed input fields can be perceived by a passenger P (who is not sight-impaired), in particular in poor lighting conditions. The illumination device 34 can also illuminate the user interface or individual input fields with colored light in order to confirm, for example, the input of the elevator call. In one exemplary embodiment, the illumination device 34 comprises one or more LED light sources.

On the elevator operating device 4, a passenger can select a destination floor by touching one of the displayed input buttons, and thus input an elevator call (destination call) for a desired destination floor. When a car 10 is allocated to this destination call, the central control and processing device 32 actuates the touchscreen 11 (or its processor 28) in order to display on the user interface an identifier for the car 10 responding to the destination call (e.g., a letter or a number) and possibly directional information. In addition, the central control and processing device 32 can actuate the audio device 9 in order to generate a corresponding voice message (e.g., car and directional information). This helps, in particular, the passenger P who has limited vision in orienting himself in the building after the call input.

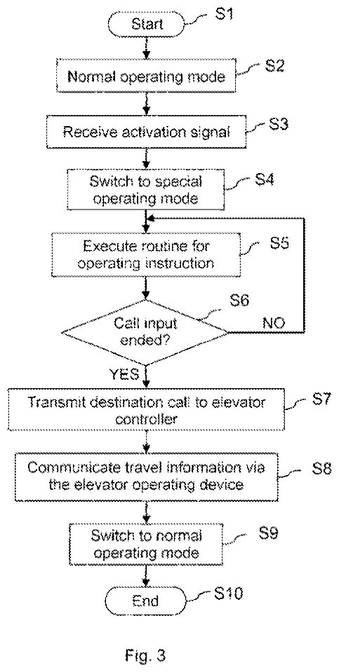

The radio device 5 is configured to receive the activation radio signal, convert it into an electrical activation signal and forward it to the central control and processing device 32. The central control and processing device 32 recognizes that it is an activation signal and thereupon causes the elevator operating device 4 to switch from the normal operating mode to the special operating mode. In the special operating mode, the central control and processing device 32 executes a defined and stored routine, as is described elsewhere in this description in conjunction with FIG. 3.

An alternative or additional possibility for the call input can be provided in an exemplary embodiment of the elevator operating device 4. In this possibility, a portable communication device (e.g., mobile radio device/mobile phone, smart phone, tablet PC) of a passenger P can be used for call input, wherein the communication between the radio device 5 and the communication device also takes place, for example, in accordance with the aforementioned Bluetooth technology.

In the exemplary embodiment shown, the radio device 7, the acoustic signal generator 42, a processor 40, an actuation device 38 and the (optional) illumination device 44 are arranged in the housing 36 of the activation device 6. The processor 40 is directly or indirectly connected to the named components; for example, the processor 40 controls the radio device 7 when the actuation device 38 generates an actuation signal when actuated by the passenger P. The radio device 7 then sends the activation signal.

In one exemplary embodiment, the processor 40 controls the acoustic signal generator 42 so that it generates an audible sound signal. The sound signal can be, for example, a clocked harmonic (audible) sound signal with a low clock frequency. In the field of assisting the blind, for example, acoustic signal generators are known, which generate a sound signal with a clock frequency of approximately 1-4 Hz. The sound signal serves as a position signal, on the basis of which the passenger P can orient himself in space and move in the direction of the signal generator 42.

In one exemplary embodiment, the functionality of the actuation device 38 and the functionality of the radio device 7 may be integrated in a module, for example a pushbutton transmitter module configured according to BLE (Bluetooth) technology (PTM 215B from EnOcean GmbH, Oberhaching, Germany). This module has a plurality of pushbuttons or toggle switches, a Bluetooth radio device and an electrodynamic energy converter, which is provided for supplying energy to the module. When one of the pushbuttons is pressed, the electrodynamic energy converter supplies the energy for transmitting a Bluetooth signal. The person skilled in the art recognizes that a battery can additionally be provided in the activation device 6 in order, for example, to operate the acoustic signal generator 42 and possibly the (optional) illumination device 44 even when no pushbutton has been pressed and the electrodynamic energy converter is not supplying electrical energy.

The communication network 22 connects the elevator operating devices 4 to the elevator controller 13 and thus makes communication possible between the elevator controller 13 and the elevator operating devices 4. For this communication, the elevator operating devices 4 and the elevator controller 13 may be directly or indirectly connected to the communication network 22. The communication network 22 can comprise a communication bus system, individual data lines, or a combination thereof. Depending on the implementation of the communication network 22, individual addresses and/or identifiers may be allocated to the elevator controller 13 and each elevator operating device 4, such that, for example, the elevator controller 13 can send a message to a desired elevator operating device 4 in a targeted manner. Communication can take place in accordance with a protocol for wired communication, for example the Ethernet protocol. As has been mentioned, in one exemplary embodiment the elevator operating devices 4 are supplied with electrical energy via the communication device 30 (PoE).

With the understanding of the above-described basic system components of the elevator system 1 and their functionalities, a description of an example of a method for operating the elevator system 1 shown in FIG. 1, in particular of one of its elevator operating devices 4, is given below with reference to FIG. 3. FIG. 3 shows an example of a flow chart of the method; it begins at step S1 and ends at step S10. A person skilled in the art will recognize that the division into these steps is by way of example, and that one or more of these steps may be divided into one or more sub-steps, or that several of the steps may be combined into one step.

The method is described with reference to a passenger P who has one of the vision disabilities mentioned. It is assumed here that the passenger P is already arranged on a floor L, L1 within reach an activation device 6 arranged there; for example, the passenger P was moving with the aid of the sound signal and/or the blind guidance system to the activation device 6, because he wishes to use the elevator in order to be conveyed from this floor L, L1 to a destination floor L, L1. As indicated in FIG. 1, the elevator operating device 4 is arranged close to the activation device 6. The elevator system 1 is equipped with a destination call controller, in accordance wherein the user interface of the elevator operating device 4 shows, for example, numbered input fields for destination floor and possibly associated floor-specific information. The elevator operating device 4 is in the normal operating mode, which in FIG. 3 is indicated by a step S2; in another representation of the flow chart, the step S2 can even be omitted.

When the passenger P actuates the activation device 6, in particular its actuation device 38, the radio device 7 sends an activation signal. In a step S3, the radio device 5 of the elevator operating device 4 receives the activation signal. In one exemplary embodiment, the activation signal can be encoded and/or comprise an identifier so that the elevator operating device 4 clearly recognizes that the received activation signal originates from the adjacently arranged activation device 6 and not from another Bluetooth transmitter.

In response to the received activation signal, the elevator operating device 4 switches in a step S4 from the normal operating mode to a special operating mode. In the special operating mode, the audio device 9 can in one embodiment be activated for a voice output and a voice input. In another exemplary embodiment, in addition to or alternatively to the audio device 9 the touchscreen 11 can be activated for a character and/or gesture recognition.

In the special operating mode, the elevator operating device 4 executes in a step S5 a routine for an operating instruction. The operating instruction can consist, for example, of the audio device 9, by means of one or more (stored) voice messages, greeting the passenger P, informing him where he is and prompting him to speak the desired destination floor as a number or floor-specific indication (e.g., a restaurant, parking garage, entry hall). The audio device 9 can be equipped with a speech recognition module for such a voice input. A voice message generated by the audio device 9 can inform the passenger P about the recognized destination floor and prompt him to confirm this or to repeat the destination floor.

In one exemplary embodiment, the audio device 9 can generate a voice message that indicates the floors that can be reached from the current floor and the passenger P reacts at the desired destination floor, saying for example “stop” or the like. In conjunction with such a voice message, the touchscreen 11 can be controlled in such a way that the currently announced floor is displayed and the passenger P is prompted to touch the touchscreen 11 at the desired destination floor.

In one embodiment the voice message can prompt the passenger P to produce a proof of authorization. The proof of authorization can be configured, for example, in the form of a card-shaped carrier, in which an RFID transponder is integrated or upon which an optical code (e.g., a barcode or a QR code) is represented. The voice message can also indicate where on the elevator operating device 4 the proof of authorization is to be shown. On the basis of the proof of authorization, a destination call to a defined destination floor can be triggered.

In one exemplary embodiment, the operating instructions can consist of the audio device 9 prompting the passenger P to touch the touchscreen 11 and with the finger to write the number of the desired destination floor or the floor-specific information (e.g., a restaurant). The touchscreen 11 or the processor 28 controlling it and/or the central control device 32 are configured for such a form of character or writing recognition. A voice message generated by the audio device 9 can inform the passenger P about the recognized destination floor and prompt him to confirm this or to make a new input.

In a step S6, a check is made as to whether the call input has been completed. In one exemplary embodiment, the call input is deemed to have been terminated when the passenger P confirms the voice or character input that he has made and has been recognized by the audio device 9. In this case, the method proceeds along the YES branch to a step S7, otherwise along the NO branch back to step S5.

In the step S7, the destination call is transmitted from the elevator operating device 4 to the elevator controller 13. When the destination call is received, information about the boarding floor and the destination floor is available, such that an allocates algorithm can use this information to select and allocate a car 10 for this trip. In the exemplary embodiment shown in FIG. 1, the destination call controller 12 receives the destination call. Such allocation algorithms are known to a person skilled in the art, for example from EP 1 276 691 B1. A person skilled in the art would recognize that, depending on the design of the elevator system 1, the allocation algorithm can also be executed with the involvement of the floor-side elevator operating devices 4, as described, for example, in EP 1 276 691 B1. Which elevator car 10 has been determined is transmitted as travel information to the elevator operating device 4. Depending on the configuration of the elevator system 1, the travel information can comprise additional information, for example when the car 10 is expected to arrive at the floor. The control system 8 controls the drive machine 14, among other things, such that the allocated car 10 is moved according to the destination call.

In a step S8, the travel information is communicated to the passenger P by means of the elevator operating device 4. The audio device 9 can generate a corresponding voice message for this purpose. Depending on the elevator system 1 and the building, the voice message can also include path or directional information (e. g., to the left, to the right). The elevator operating device 4 can be configured such that communication of the travel information for the passenger P is repeated automatically or upon request.

In a step S9, the elevator operating device 4 switches from the special operating mode back to the normal operating mode. In one exemplary embodiment, the switch-over takes place once a specified period of time has elapsed after the travel information was communicated in step S8. The method ends in step S10.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. An elevator system including an elevator car controlled by an elevator controller for movement between floors of a building, the elevator system comprising:
an elevator operating device communicatively connected to the elevator controller and being arranged on one of the floors, the elevator operating device having a first radio device, an audio device and a touch-sensitive screen, the touch-sensitive screen adapted for inputting a destination floor desired by a passenger and for outputting travel information;
an activation device having an actuation device accessible to the passenger and a second radio device adapted for radio communication with the first radio device, the activation device being arranged within radio range of the elevator operating device, wherein the second radio device is configured to transmit an activation radio signal when the actuation device is actuated by the passenger; and
wherein the elevator operating device switches from a normal operating mode to a special operating mode when the activation radio signal is received by the first radio device, generates in the special operating mode an operating instruction for a call input by the passenger, and switches into the normal operating mode when the call input is complete.

15. The elevator system according to claim 14 wherein the elevator operating device confirms the call input to the passenger through the audio device and/or the touch-sensitive screen.

16. The elevator system according to claim 14 wherein the operating instruction is a voice instruction communicated through the audio device.

17. The elevator system according to claim 14 wherein the elevator operating device has a housing and the activation device has a housing, the housing of the activation device being arranged adjacent to the housing of the elevator operating device.

18. The elevator system according to claim 14 wherein the elevator operating device has a housing and the activation device has a housing, the housing of the activation device being arranged on the housing of the elevator operating device.

19. The elevator system according to claim 14 wherein the activation device has an identification device that identifies the activation device as intended for use by a passenger with a physical limitation.

20. The elevator system according to claim 19 wherein the activation device includes an acoustic signal generator that generates an audible position signal.

21. The elevator system according to claim 14 wherein the touch-sensitive screen that displays input fields assigned to destination floors, detects a touch in one of the input fields, and displays travel information determined for a destination call corresponding to the detected touch.

22. The elevator system according to claim 14 wherein the second radio device transmits the activation radio signal in accordance with a Bluetooth technology, and wherein the first radio device receives the activation radio signal in accordance with the Bluetooth technology.

23. The elevator system according to claim 14 wherein the elevator controller determines in the special operating mode travel information for the call input and communicates the determined travel information to the passenger by the elevator operating device.

24. A method for operating the elevator system according to claim 14, wherein the elevator operating device communicatively connected to the elevator controller is arranged on the one floor, the activation device is arranged on the one floor within radio range of the elevator operating device, and the elevator operating device is adapted to switch between the normal operating mode and the special operating mode, the method comprising the steps of:
receiving via the elevator operating device an activation signal initiated by a passenger at the activation device;
activating the special operating mode of the elevator operating device after reception of the activation signal, wherein the elevator operating device switches from the normal operating mode to the special operating mode;
executing by the elevator operating device a routine for an operating instruction, whereby during a call input at the elevator operating device the elevator operating device assists the passenger who has initiated the activation signal;
after completion of the call input by the passenger, transmitting by the elevator operating device to the elevator controller a destination call corresponding to the call input;
communicating travel information via the elevator operating device, wherein the travel information indicates an elevator car determined by the elevator controller and allocated to the destination call; and
deactivating the special operating mode of the elevator operating device once the communication of the travel information has finished, wherein the elevator operating device then switches from the special operating mode to the normal operating mode.

25. The method according to claim 24 wherein the activation radio signal is emitted by the second radio device in accordance with a Bluetooth technology and wherein the activation radio signal is received by the first radio device in accordance with the Bluetooth technology.

26. The method according to claim 24 including generating an audible position signal by an acoustic signal generator of the activation device.
